(19) United States
(12) Patent Application Publication
(10) Pub. No.: US 2015/0277720 A1
(43) Pub. Date: Oct. 1, 2015

(54) Systems and Methods for Managing Operating Modes of an Electronic Device

(71) Applicant: GOOGLE TECHNOLOGY HOLDINGS LLC, MOUNTAIN VIEW, CA (US)

(72) Inventors: Dean E Thorson, Grayslake, IL (US); Roger W. Ady, Chicago, IL (US); James E. Bender, Cary, IL (US)

(21) Appl. No.: 14/229,052

(22) Filed: Mar. 28, 2014

(51) Int. Cl. G06F 3/0484; H04N 5/232; G06F 3/0485; G06F 3/0482; G06F 3/041; G06F 3/044

(52) U.S. Cl. CPC G06F 3/04847; G06F 3/0412; G06F 3/044; G06F 3/0416; G06F 3/04842; G06F 3/0485; G06F 3/0482; H04N 5/23216

(57) ABSTRACT

Embodiments are provided for enabling a user of an electronic device to select functions and facilitate operations while the electronic device is partially or fully submerged in a conductive material. According to certain aspects, the electronic device can analyze (934) contact data to determine that it is submerged in a conductive material. In some cases, the electronic device can initiate (938) various operating modes such as an imaging mode (940), an audio mode (949), a scrollable menu (954), or an illumination mode (968). The electronic device detects (944, 950, 956, 966) an actuation of a hardware button and performs (948, 952, 958, 968) a specified function according to the operating mode.

### FIELD

This application generally relates to user interaction with electronic devices that are at least in a partially submerged state. In particular, the application relates to platforms and techniques for enabling users to select functions and facilitate operations of an electronic device when the electronic device is submerged.

### BACKGROUND

Electronic devices such as smart phones are equipped with a wide variety of sensors that support various functionalities and applications. For example, a user may use a camera application and image sensor of an electronic device to capture and store digital images. Many existing electronic devices are also equipped with capacitive touch-sensitive user interfaces that support users making various selections and facilitate various functions via touch events. However, the electronic devices are unable to detect certain touch events when in certain environments.

In particular, if an electronic device is dropped or placed in a conductive medium such as water, the water will cause a change in the capacitive charge field on all or nearly all of the locations of a capacitive touch-sensor in contact with the water, which prevents the user interface from detecting touch events from a user. The conductive medium therefore causes a change in capacitance, like that resulting from a finger touch event, as a result of the electronic device being submersed in the conductive medium. Therefore, the user is unable to make selections and facilitate functions via the user interface while the electronic device is submerged.

Accordingly, there is an opportunity to enable users to facilitate functionalities and operating modes of electronic devices while the electronic devices are submerged.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIGS. 1 and 2 depict example electronic devices capable of facilitating various operating modes and functionalities while submerged, in accordance with some embodiments.

FIG. 3 depicts a cross-section view of an example user interface, in accordance with some embodiments.

FIG. 4 depicts an example representation of various states of submersion of an electronic device, in accordance with some embodiments.

FIG. 5 depicts example interfaces associated with image and video capturing on an electronic device, in accordance with some embodiments.

FIG. 6 depicts example interfaces associated with audio recording on an electronic device, in accordance with some embodiments.

FIG. 7 depicts example interfaces associated with an illumination mode of an electronic device, in accordance with some embodiments.

FIG. 8 depicts example interfaces associated with techniques for scrolling through a menu displayed on an electronic device, in accordance with some embodiments.

FIG. 9 depicts a flow diagram of an electronic device detecting submersion and facilitating various operating modes and functionalities while submerged, in accordance with some embodiments.

FIG. 10 is a block diagram of an electronic device in accordance with some embodiments.

FIGS. 11-13 depict cross-section views of actuator components associated with various configurations of an example hardware button of an electronic device in accordance with some embodiments.

FIGS. 14-17 illustrate various graphs indicating measured capacitance values from a capacitive panel in response to various inputs in accordance with some embodiments.

### DETAILED DESCRIPTION

Generally, users are spending an increasing amount of time interacting with various mobile electronic devices such as smart phones and tablets. Typically, the mobile devices are equipped with capacitive touch-sensitive user interfaces. For example, the user interfaces incorporate capacitive touch panels that can sense user contact, for example via a user's finger creating a touch event. Users can select various functions and control various operations of the mobile devices via these touch events. With the increasing capabilities of mobile devices, it is increasingly desirable for users to be able to interact with their mobile devices in a wide variety of situations and environments.

When an electronic device is submerged in a medium that is conductive, touch pixels of the capacitive touch-sensitive user interface can be used to detect partial or complete submersion. For example, non-purified water is a conductive material capable of “activating” touch pixels of a capacitive touch panel of an electronic device. If the electronic device is fully submerged, the conductive medium contacts the entire user interface (i.e., many pixels along the entire capacitive touch panel will activate), and the user interface is not able to detect any additional contact (e.g., a user's finger). Therefore, a user will not be able to leverage the user interface to select or facilitate the functions and operations that are normally activating using the capacitive touch-sensitive user interface. In addition, if the device is partially submerged, the portion of the capacitive touch panel that is submerged will “activate” and also limit the ability of the user to leverage the corresponding portion of the user interface to select or facilitate the functions and operations that may be normally activated using the capacitive touch-sensitive user interface. The techniques as discussed herein for managing various operating modes of the electronic device may be implemented when the electronic device is either partially submerged or fully submerged.

The term “activate” as used herein may refer to a sensor location of the capacitive touch sensitive user interface changing its state, which indicates that the surface is being touched in that sensor location. The state change can be, but is not limited to, a change in the resonant frequency of a circuit connected to the position or a change in the impedance measured with respect to ground at that sensor location.

According to embodiments, an electronic device can detect when it is submerged or partially submerged in a conductive medium by virtue of at least a portion of its user interface being capacitively coupled to its exterior casing. Responsive to detecting a submerged or partially submerged state, the electronic device can modify its operating mode to enable a user to select certain features or functions supported by the electronic device using an alternate user interface that is not affected by the submersion. In some embodiments, the electronic device may switch its mutual capacitance measurement to a self-capacitance measurement with a known reference baseline that may be factory set, whereby the self-capacitance measurements are detected via single touch events. When the operating mode is modified, the user interface can instruct the user to select one or more hardware buttons that correspond to one or more of the features or functions. When the user actuates a certain hardware button, the electronic device can perform the corresponding function. The embodiments as discussed herein therefore offer a benefit to users of the electronic devices by enabling the users to facilitate certain applications and functionalities while the electronic devices are submerged or partially submerged in a conductive medium. This benefit is especially important as electronic devices become more advanced and more ubiquitous.

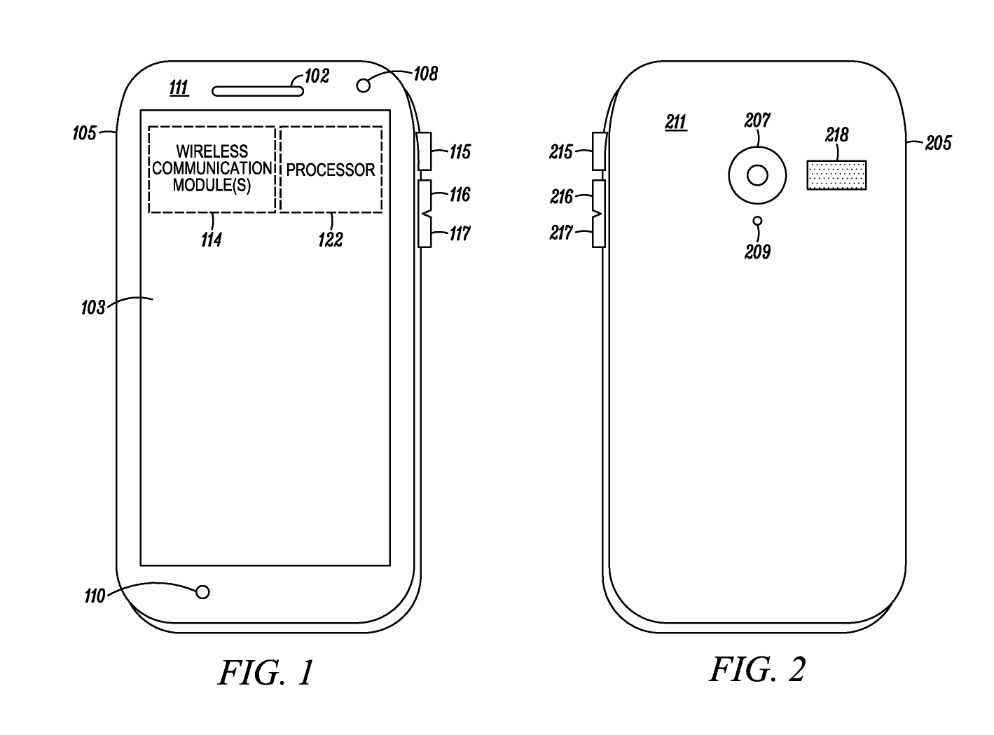

FIG. 1 depicts a front view of an example electronic device 105 configured to detect submersion and facilitate various functions and operations while submersed. The electronic device 105 may be any type of portable electronic device, for example, a notebook computer, a mobile phone, a Personal Digital Assistant (PDA), a smart phone, a tablet computer, a multimedia player, an MP3 player, a digital broadcast receiver, a remote controller, a digital camera, a digital video recorder, or any other electronic apparatus.

Generally, the exterior of the electronic device 105 may be defined by a capacitive touch-sensor user interface 103 (e.g., a touchscreen or a touchpad) and an exterior casing 111. The user interface 103 is configured to display content and receive or detect input from a user of the electronic device 105. The exterior casing 111 may take up various remaining portions or surfaces of the electronic device 105, and may be designed to house or enclose various interior components of the electronic device 105. The exterior casing 111 may include one or multiple pieces or components, and may be composed of various materials (e.g., plastic, metal, glass, etc.) or combinations of materials. As illustrated in FIG. 1, at least a portion of the exterior casing 111 can surround or otherwise contact the user interface 103 such that the exterior casing 111 is mechanically coupled to the user interface 103.

The electronic device 105 can include audio components such as a speaker 102 and a microphone 110. The speaker 102 is configured to output audio based on an electrical audio signal and the microphone 110 is configured to convert detected sound into an electrical signal. As illustrated in FIG. 1, the speaker 102 is an “earpiece” speaker that is commonly utilized by the user during telephone calls or similar applications. It should be appreciated that the types, sizes, and locations of the speaker 102 and the microphone 110 are merely examples and that other types, sizes, and locations are envisioned.

The electronic device 105 can further include various sensors configured to capture image data and detect other general environment data associated with the electronic device 105. In particular, the electronic device 105 can include an image sensor 108 configured to capture digital images and generate resulting imaging data (e.g., digital photos and digital videos). It should be appreciated that various locations, types, and sizes of the image sensor 108 are envisioned. Further, it should be appreciated that the electronic device 105 can include other sensors, such as a proximity sensor, gyroscope, light sensor, accelerometer, location module (e.g., a Global Positioning System (GPS) module), and/or other sensors.

The electronic device 105 can further include one or more hardware buttons 115, 116, 117 that are each adapted for actuation by a user of the electronic device 105. A user actuating one or more of the hardware buttons 115, 116, 117 can cause the electronic device 105 (or any component or application thereof) to initiate, perform, or execute one or more corresponding functions. For example, if the electronic device 105 is executing a music playback application and detects that a user actuates the hardware button 116, the electronic device 105 can cause its speaker 218 to increase its output volume. According to embodiments, the functions that correspond to actuation of the hardware buttons 115, 116, 117 may vary depending on a currently-executing application or function.

FIG. 2 illustrates a back view of an example electronic device 205 (such as a back view of the electronic device 105 discussed with respect to FIG. 1). The electronic device 205 can include an image sensor 207 configured to capture digital images and generate resulting imaging data (e.g., digital photos and digital videos), as well as an illumination component 209 to assist in the capture of the optical images. In embodiments, the illumination component 209 can be an LED or LED array, panel, or backlight, or any other type of lighting component configured to illuminate continuously or in bursts.

The electronic device 205 can further include at least one speaker 218 (e.g., a “built-in” speaker) configured to output audio based on an electrical audio signal. As illustrated in FIG. 2, the image sensor 207, the speaker 218, and the illumination component 209 are surrounded by an exterior rear casing 211 (i.e., the exterior casing 211 is formed to enable the image sensor 207, the speaker 218, and the illumination component 209 to be disposed therein). The exterior rear casing 211 may be separate from or an extension of the exterior front casing 111 illustrated in FIG. 1. It should be appreciated that the front side of the electronic device 105 and the back side of the electronic device 205 (and the components thereof) can be of various shapes and sizes. It should further be appreciated that the various sensors and audio components of the electronic device 105, 205 may be multiplicatively located on multiple sides of the electronic device 105, 205 or otherwise located on a side of the electronic device 105, 205 that is not depicted in FIGS. 1 and 2. For example, another microphone can be located on the back side of the electronic device 205 or on an edge side (not shown) of the electronic device.

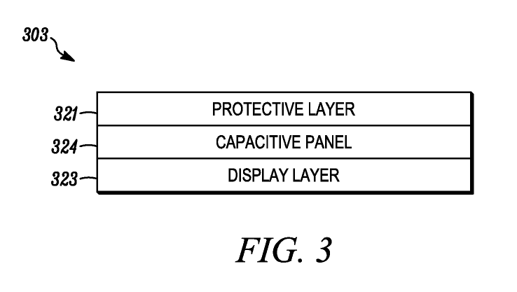

The touchscreen user interface 103 as illustrated in FIG. 1 can include various components and layers. FIG. 3 depicts simplified a cross-section view of various components and layers of an example touchscreen 303. In particular, the touchscreen 303 includes a display layer 323, a capacitive panel 324, and a protective layer 321. The display layer 323 may include an LED, OLED, and/or LCD array, or other types of display components that are viewable by a user. The capacitive panel 324 can detect capacitive user input (e.g., from a touch event). The pixels of the display layer 323 do not have to match the alignment or size of the pixels of the capacitive panel 324. The protective layer 321 can be a transparent layer disposed on top of the capacitive panel 324 and the display layer 323, and configured to protect the capacitive panel 324 and the display layer 323. It should be appreciated that additional or alternative layers for the touchscreen 303 are envisioned.

Referring back to FIG. 1, the electronic device 105 further includes a processor 122 that is configured to process signals and data associated with components of the electronic device 105 and facilitate various functions based on the signals and data. According to one particular functionality, the processor 122 is configured to interface with the user interface 103 to determine whether the electronic device 105 is submerged or partially submerged in a conductive material such as water. Generally, any non-distilled water is a conductive material that is detectible by the capacitive panel of the user interface 103. If the electronic device 105 is submerged in a conductive material, the entire capacitive panel will “activate” (i.e., sense capacitive contact). Further, when the electronic device 105 is submerged, the capacitive panel will fail to detect any additional capacitive contact, such as a user's finger contacting the user interface 103. In this situation, the capacitive panel will not generate additional contact data and the processor 122 is not able to facilitate functions according to the contact data that the capacitive panel would otherwise generate if the electronic device 105 was not submerged.

If the electronic device 105 is partially submerged, the portion of the capacitive panel that is submerged will “activate” and will fail to respond to additional capacitive contact. According to some embodiments, the electronic device 105 may set a threshold for a contiguous percentage of the capacitive panel that is “activated,” which can cause the electronic device 105 to perform the same or similar actions as described herein for when the electronic device 105 is fully submerged. Although the descriptions contained herein generally describe the conductive material as water, it should be appreciated that submersion in other conductive liquid or near-liquid materials such as gels are envisioned.

In operation, the processor 122 is configured to receive signal or contact data from the capacitive panel of the user interface 103 and examine the contact data to determine whether the capacitive panel is capacitively coupled to a ground potential such as the floating ground of the exterior casing 111. Generally, if the contact data indicates that the entire capacitive panel is “active,” the capacitive panel is capacitively coupled to the exterior casing 111 and the electronic device 105 is likely fully submerged in a conductive material. Conversely, if the contact data indicates that at least a portion of the capacitive panel is not “active” (e.g., if only half of the capacitive panel is disposed in the conductive material), the entire capacitive panel is not capacitively coupled to the exterior casing 111 and the electronic device 105 is likely not fully submerged in a conductive material. If the contact data indicates that a contiguous area of the capacitive panel is “active,” and that a percentage of the contiguous area relative to the area of the capacitive panel has exceeded a certain threshold (e.g., 20%, 40%, 60%, etc.), then the electronic device 105 may be considered partially submerged.

The processor 122 is configured to automatically receive updated contact data from the capacitive panel to determine when the electronic device 105 enters a partial or fully submerged state (i.e., enters a conductive material) as well as exits a partial or fully submerged state (i.e., is removed from a conductive material). In some embodiments, if the electronic device 105 determines that a contiguous “activated” area of the capacitive panel falls below (or rises above) a detection comparison threshold, then the electronic device 105 may be considered to have exited (or to have entered) the submerged state. The processor 122 may also be configured to determine whether the electronic device is submerged in a conductive material according to various shifts in signal levels.

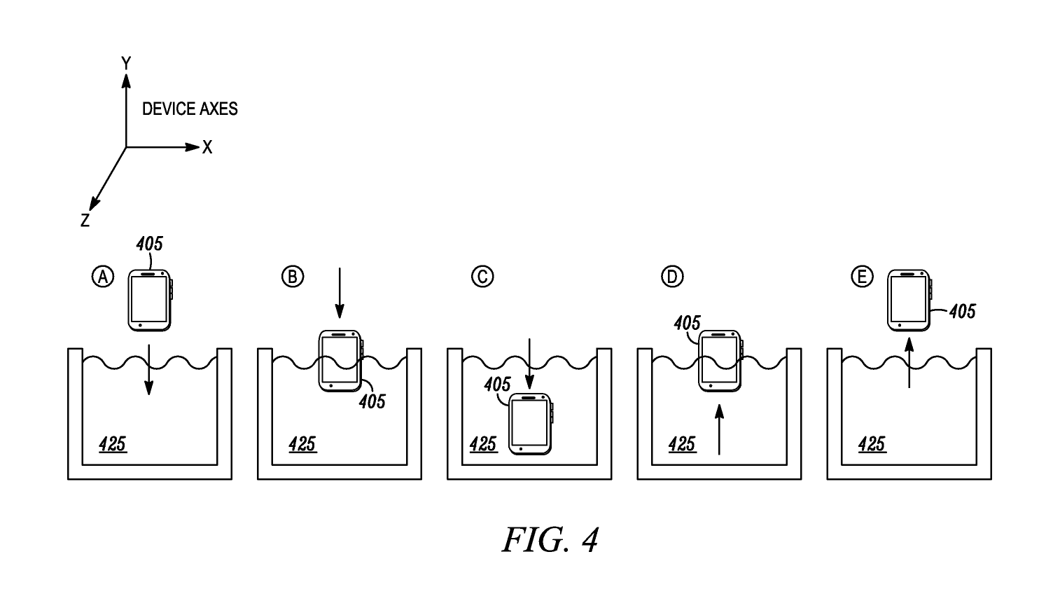

Referring to FIG. 4, illustrated are various example states of an electronic device 405 (such as the electronic device 105 discussed with respect to FIG. 1) either fully submerged, partially submerged, or not submerged in a conductive material 425. The electronic device 405 is oriented in the +/−Y direction as indicated by the “device axes.” It should be appreciated that the electronic device 405 performs similar submersion detection techniques when the electronic device 405 is oriented in the +/−X direction, but different submersion detection techniques when the electronic device 405 is oriented in the +/−Z direction.

On the left side of FIG. 4 (“A”), the electronic device 405 is not submerged in the conductive material 425 and none or a small portion of the capacitive panel will activate. By following a downward direction as indicated by the arrow, the electronic device 405 is partially submerged in the conductive material 425 as indicated in the second section of FIG. 4 (“B”). The electronic device 405 can determine that it is partially submerged when it detects that a certain percentage (e.g., 20%, 40%, 60%, etc.) of its capacitive panel is active. Further, the electronic device 405 can detect when it enters a partially submerged state when the active area of its capacitive panel increases above the certain percentage (e.g., when the active area increases from 39% to 41%). The electronic device 405 can account for any activation of the capacitive panel caused by “splashes” on the way into the conductive material 425. The center section of FIG. 4 (“C”) illustrates the electronic device 405 in a fully submerged state, which the electronic device 405 can detect when its entire capacitive panel is active.

The electronic device 405 may exit the conductive material 425 as indicated on the right side of FIG. 4. In particular, by following a upward direction as indicated by the arrow, the electronic device 405 is once again partially submerged in the conductive material 425 as indicated in the fourth section of FIG. 4 (“D”). The electronic device 405 can determine that it is partially submerged when it detects that a certain percentage (e.g., 20%, 40%, 60%, etc.) of its capacitive panel is active. Further, the electronic device 405 can detect when it exits a partially submerged state when the active area of its capacitive panel decreases below the certain percentage (e.g., when the active area decreases from 41% to 39%). The electronic device 405 can determine when it has exited the conductive material 425 (as depicted by “E” in FIG. 4) when none or a small portion of its capacitive panel is active. The electronic device 405 can account for any activation of the capacitive panel caused by “drips” in response to exiting the conductive material 425.

According to embodiments, the processor 122 is configured to initiate various operating modes of the electronic device 105 in response to determining that the electronic device 105 is submerged. The various operating modes can incorporate the various sensors of the electronic device 105. For example, the operating modes may include audio capture using the microphone 110, image and/or video capture using the image sensors 108 and/or 207, illumination mode using the illumination component 209, and/or other modes. The processor 122 may further cause the user interface 103 to display indications and information associated with the operating modes, such as various menus, interfaces, or selections that indicate various functions of the operating modes. In some embodiments, the processor 112 may deactivate or disable one or more wireless communication modules 114 of the electronic device 105 so that the electronic device 105 does not waste power attempting to transmit and receive while submerged. The antennas of a wireless transceiver that are tuned for an air medium will be highly inefficient when transmitting or receiving in a non-air medium.

As discussed herein, when the electronic device 105 is partially or fully submerged in a conductive material, the user interface 103 is unable to detect capacitive user input beyond that of the conductive medium, and therefore a user is unable to make touch selections via the capacitive user interface 103 to facilitate the various operating modes. However, according to embodiments, the processor of the electronic device 105 may configure the hardware buttons 115, 116, 117 to enable the user to make various selections and facilitate the operating modes of the electronic device 105. Therefore, by virtue of the user interface 103 indicating the various functions of the operating modes, and the ability of the user to make selections using the hardware buttons 115, 116, 117, the user is able to effectively operate the electronic device 105 while the electronic device 105 is submerged in a conductive material.

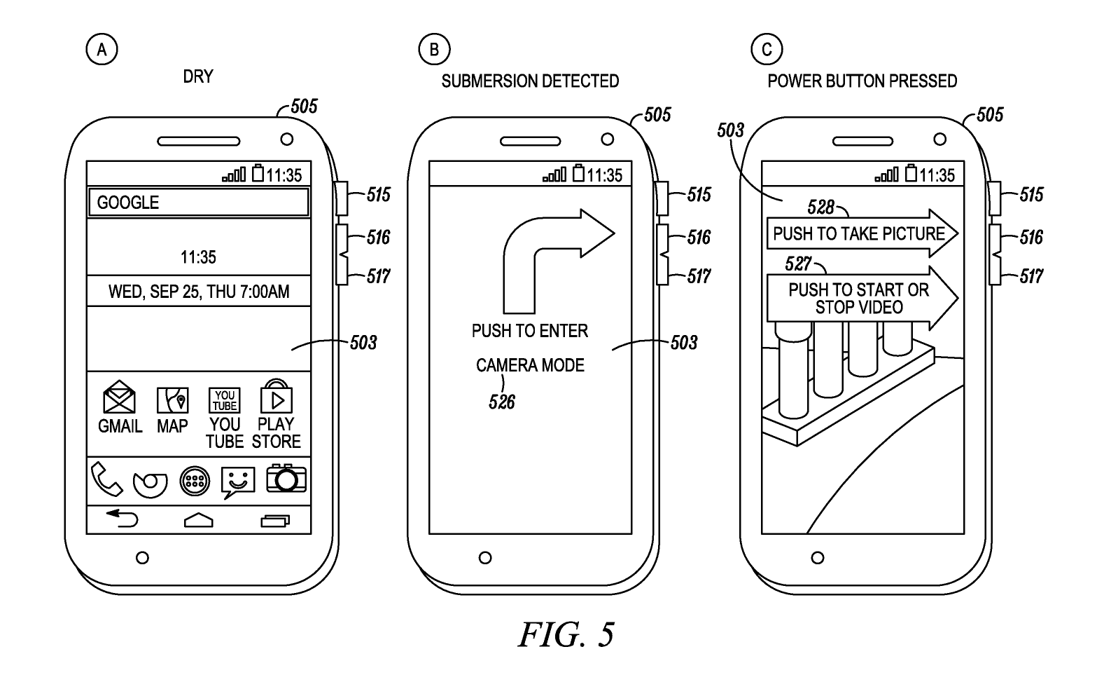

FIG. 5 illustrates multiple example interfaces displayable by a user interface 503 of an electronic device 505, illustrating an example image and video capturing mode of the electronic device 505. On the left side of FIG. 5 (“A”), the electronic device 505 is “dry” or otherwise not submerged in a conductive material. Accordingly, the user interface 503 may display a home screen or other interface associated with “normal” operation of the electronic device 505 and receive touch inputs on a capacitive user interface 503 to select various applications and functions of the electronic device 505.

When a processor of the electronic device 505 determines that the electronic device 505 is submerged (partially or fully) in a conductive material (as indicated by “B” in FIG. 5), the processor can cause the user interface 503 to indicate a particular operating mode and functionalities associated therewith. As illustrated in FIG. 5, the operating mode is a camera mode associated with capturing images and/or videos. The user interface 503 indicates an instruction 526 for the user to select or actuate a hardware button 515 to enter the camera mode.

The processor can detect an actuation of the hardware button 515 by the user and can cause the user interface 503 to indicate the camera mode and display functionalities associated therewith (as indicated by “C” in FIG. 5). In particular, as illustrated in FIG. 5, the user interface 503 can display a live preview of image data detected by an image sensor of the electronic device 505. Further, the user interface 503 can indicate an image capture function 528 (“push to take picture”) and a video capture function 527 (“push to start or stop video”). By actuating an associated hardware button 516, the user can cause the image sensor to capture a digital image. Similarly, by actuating an associated hardware button 517, the user can cause the image sensor to start or stop recording a digital video. Thus, the submerged touchscreen is no longer used to select the camera application and control its functions.

It should be appreciated that other functions associated with a general image/video capture operating mode are envisioned. In particular, the electronic device 505 may modify a particular image capture setting in response to detecting submersion. For example, the optimal shutter speed and/or aperture of an image sensor may differ depending on whether the electronic device 505 is submerged or not submerged, and the electronic device 505 may automatically modify each setting accordingly. For further example, the electronic device 505 may automatically disable an auto-focus setting of the image sensor in response to detecting submersion. Similarly, the electronic device 505 may perform other image capture-related functionalities in response to the user actuating one of the hardware buttons 515, 516, 517. For example, if the user actuates the hardware button 516 (or the hardware button 517), the image sensor may optically zoom in (or zoom out).

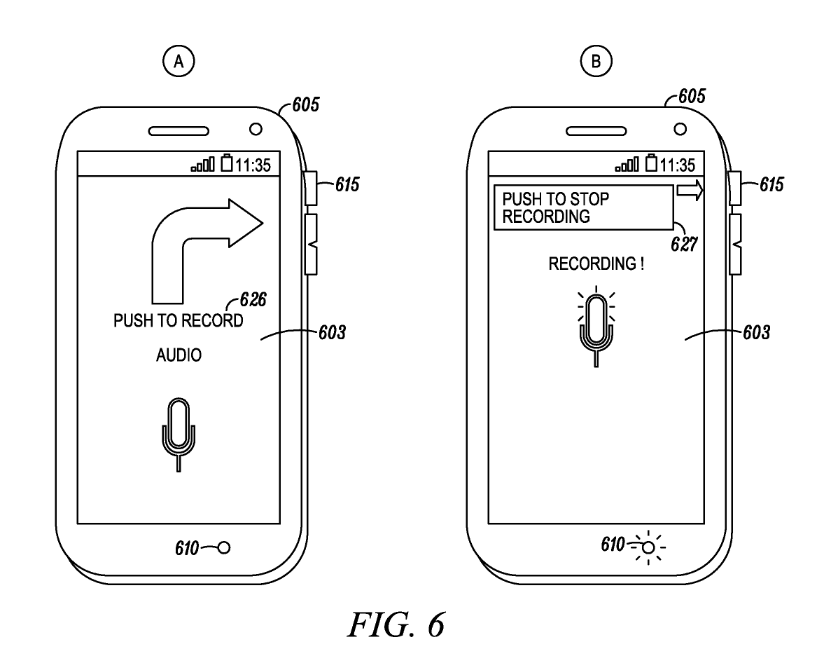

FIG. 6 illustrates multiple example interfaces displayable by a user interface 603 of an electronic device 605, illustrating an example audio recording mode of the electronic device 605. The user interface 603 can display the interface on the left side of FIG. 6 (“A”) in response to the processor determining that the electronic device 605 is submerged in a conductive material. In particular, the interface indicates an instruction 626 for the user to select or actuate a hardware button 615 to enter an audio recording mode for recording audio via a microphone 610. The processor can detect an actuation of the hardware button 615 by the user and can cause the microphone 610 to record audio and the user interface 603 to display an indication of the audio recording as well as an instruction 627 to stop the audio recording (as indicated by “B” in FIG. 6).

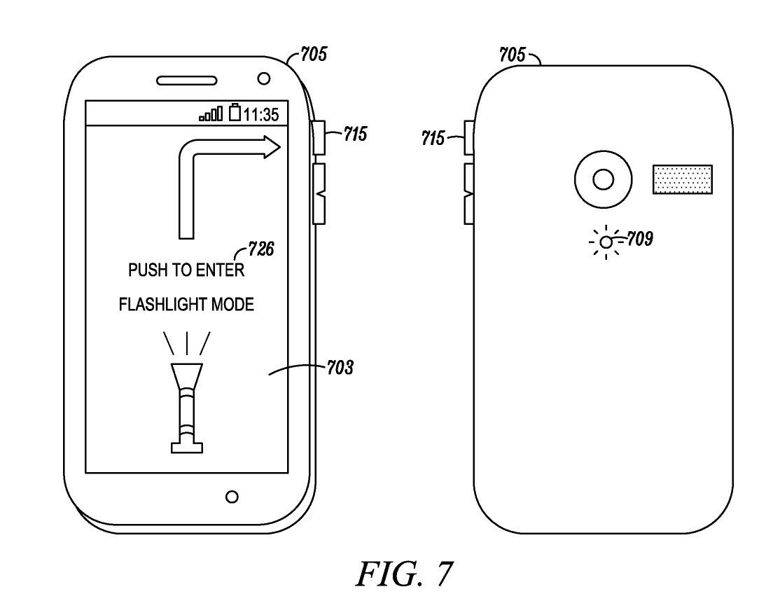

FIG. 7 illustrates an example interface displayable by a user interface 703 of an electronic device 705, illustrating an example “flashlight mode” of the electronic device 705. The user interface 703 can display the interface indicated on the left side of FIG. 7 in response to the processor determining that the electronic device 705 is submerged in a conductive material. In particular, the interface indicates an instruction 726 for the user to select or actuate a hardware button 715 to enter the flashlight mode. The processor can detect an actuation of the hardware button 715 by the user and can cause an illumination component 709 to illuminate and provide light in a vicinity of the electronic device 705 (as indicated on the right side of FIG. 7).

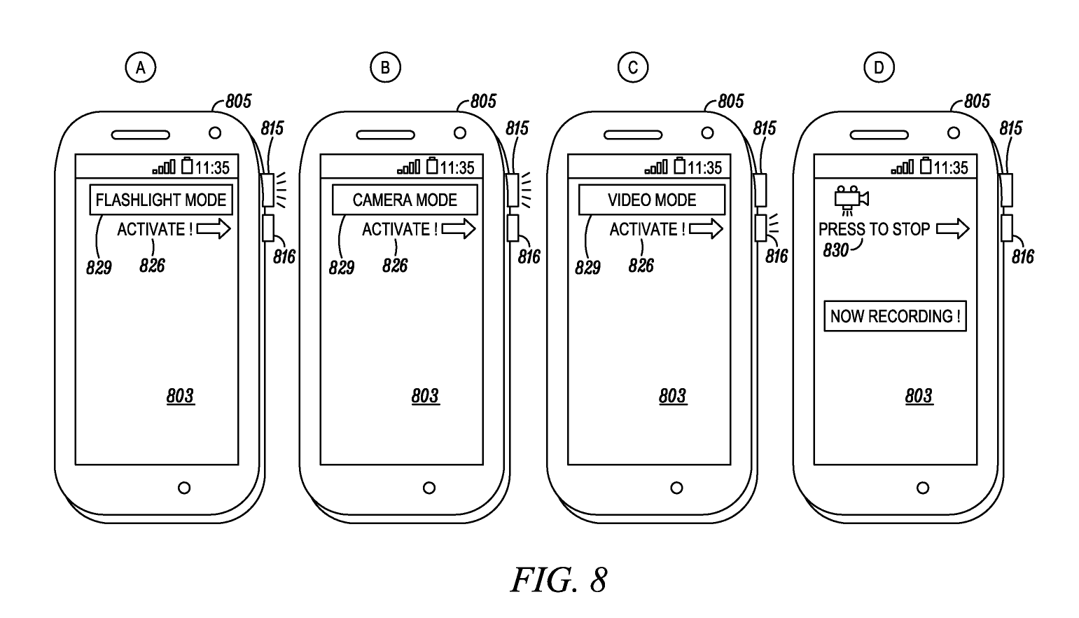

FIG. 8 illustrates example interfaces displayable by a user interface 803 of an electronic device 805, illustrating techniques for scrolling through a scrollable menu. As illustrated in FIG. 8, the scrollable menu indicates multiple example operating modes of the electronic device 805. The user interface 803 can display the interface on the left side of FIG. 8 (“A”) in response to the processor determining that the electronic device 805 is submerged in a conductive material. In particular, the interface of “A” indicates a scrollable menu 829 with a selectable function (as shown: “flashlight mode”) and an instruction 826 for the user to select or actuate a hardware button 816 to activate the selectable function displayed in the scrollable menu 829.

If the user instead selects a hardware button 815, the scrollable menu 829 displays a different selectable function (as shown: “camera mode”), as indicated by the “B” interface in FIG. 8. The scrollable menu 829 as indicated by the “B” interface indicates the instruction 626 for the user to select or actuate the hardware button 816 to activate the camera mode indicated in the scrollable menu 829. If the user again selects the hardware button 815, the scrollable menu 829 displays a different selectable function (as shown: “video mode”), as indicated by the “C” interface in FIG. 8. The scrollable menu 829 as indicated by the “C” interface indicates the instruction 826 for the user to select or actuate the hardware button 816 to activate the video mode indicated in the scrollable menu 829.

As illustrated in the “C” interface of FIG. 8, the user selects the hardware button 816 and the “D” interface indicates (“now recording!”) the video mode and indicates an instruction 830 to select or actuate the hardware button 816 to stop recording. Of course, the “D” interface can include additional or alternative content, such as a live preview window of image data captured by an image sensor.

There are many methods for using hardware buttons and a non-touch-sensitive display to guide a user through various menus to control an electronic device. The method shown in FIG. 8 can be replaced with other methods that use one or more hardware buttons and a display rather than a capacitive touch panel.

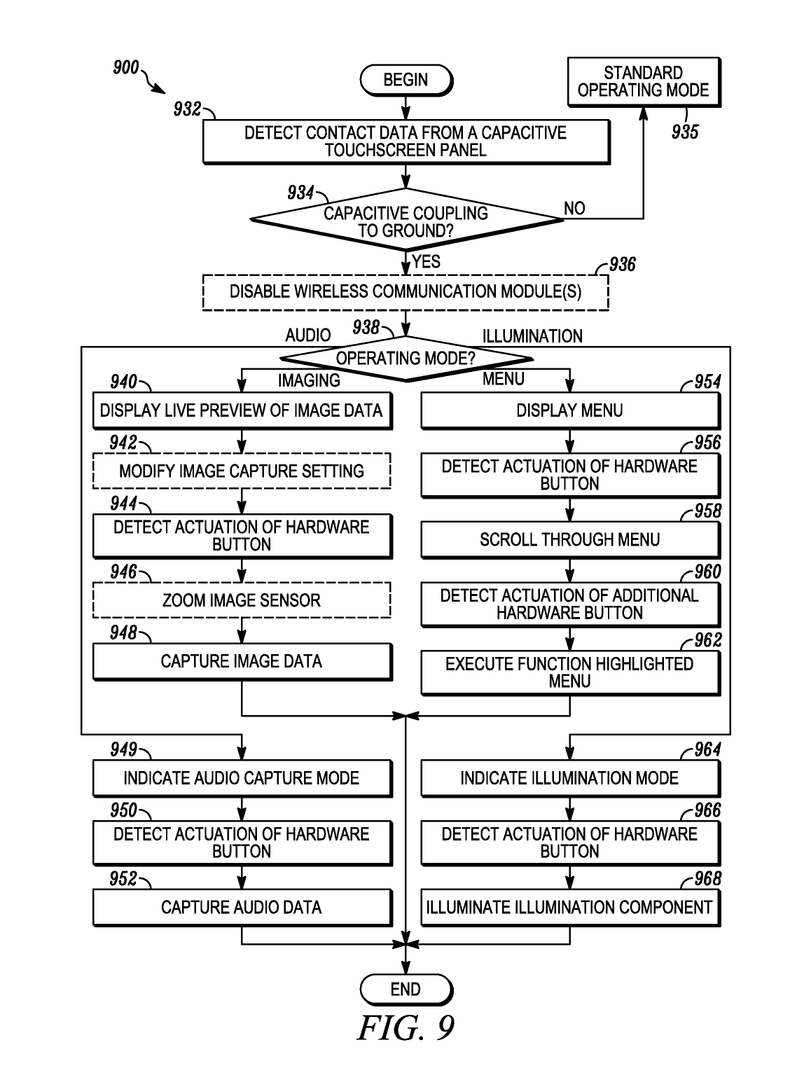

FIG. 9 is a flowchart of a method 900 for an electronic device (such as the electronic device 105) to detect device submersion and facilitate various operating modes. The order of the steps of the depicted flowchart of FIG. 9 can differ from the version shown, and certain steps can be eliminated, and/or certain other ones can be added, depending upon the implementation. The method 900 begins with the electronic device receiving or detecting 932 contact data from a capacitive touchscreen panel. The capacitive touchscreen panel can generate the contact data according to contact by a finger, conductive stylus, or other conductive material such as water.

The electronic device analyzes 934 the contact data to determine whether a large contiguous portion of the capacitive touchscreen panel is capacitively coupled to ground, for example an earth ground or a floating ground such as an exterior casing of the electronic device. In particular, if the analysis determines that no contiguous area of the capacitive touchscreen above a detection threshold (e.g., 20%, 40%, 60%, etc.) is capacitively coupled to ground (“NO”), then the analysis concludes that the electronic device is neither partially nor fully submerged in a conductive medium, and the electronic device can operate 935 as normal. In contrast, if the analysis determines that a contiguous area of the capacitive touchscreen above a detection threshold (e.g., 20%, 40%, 60%, etc.) is coupled to ground (“YES”), then the analysis concludes that the electronic device is partially or fully submerged in a conductive material and, in an optional embodiment, the electronic device disables 936 one or more wireless communication modules so that the electronic device is unable to send or receive corresponding data. This decreases power consumption of the electronic device when the device would be ineffective at transmitting and receiving wireless data in the conductive medium.

The electronic device determines 938 which function or operating mode to indicate or initiate on a user interface. In some cases, the electronic device may indicate or initiate a default function or operating mode. In other cases, a user of the electronic device may select which function or operating mode for the electronic device to indicate or initiate. If the function or operating mode is a scrollable menu (“MENU”), the electronic device displays 954 the scrollable menu in a user interface. According to embodiments, the scrollable menu is associated with a plurality of various functions operable by the electronic device (e.g., an illumination mode, an audio capture mode, a camera mode, etc.), and the scrollable menu can indicate one or more functions at a time. The electronic device detects 956 an actuation of a hardware button by the user, where the hardware button corresponds to the scrollable menu. Responsive to detecting the actuation of the hardware button, the electronic device scrolls 958 through the menu. In particular, the electronic device can cause the scrollable menu to indicate a function different than a function previously displayed by the scrollable menu. The electronic device detects 960 an actuation of an additional hardware button (e.g., a hardware button different from the hardware button of 956). The additional hardware button may correspond to the function currently highlighted or displayed by the scrollable menu. Accordingly, in response to detecting the actuation of the additional hardware button, the electronic device executes 962 the function highlighted in the scrollable menu.

If the function or operating mode is image or video capture (“IMAGING”), the electronic device displays 940 a live preview of image data captured by an image sensor of the electronic device. Accordingly, the user may view currently-captured image data of the image sensor. The electronic device optionally modifies 942 one or more image capture settings. For example, the electronic device may modify or disable settings related to aperture, focal length, shutter speed, ISO, auto focus, and/or others, to improve submersed image capture.

The electronic device detects 944 an actuation of a hardware button by a user. In embodiments, the electronic device can indicate, in a user interface, a corresponding function of the hardware button so that the user can assess the function before actuating the hardware button. In an optional embodiment, if the hardware button corresponds to a zoom function, the electronic device zooms 946 the image sensor in response to the electronic device detecting the actuation of the hardware button. In another embodiment, if the hardware button corresponds to an image/video capture function, the electronic device captures 948 image data in response to the electronic device detecting the actuation of the hardware button. It should be appreciated that the electronic device may perform the zooming and capturing of 946 and 948 in response to detecting the actuation of different hardware buttons.

If the function or operating mode is audio capture (“AUDIO”), the electronic device indicates 949 the audio capture mode in the user interface, for example by instructing a user to select or actuate a hardware button to begin recording. The electronic device detects 950 an actuation of the hardware button by the user. It should be appreciated that the hardware button of the audio capture operating mode is the same as or different from the hardware button of the image/video capture operating mode. Responsive to detecting the actuation of the hardware button, the electronic device captures 952 audio data, for example via a microphone of the electronic device.

If the function or operating mode is illumination (“ILLUMINATION”), the electronic device indicates 964 the illumination mode in the user interface, for example by instructing a user to select a hardware button to illuminate an illumination component such as an LED. The electronic device detects 966 an actuation of the hardware button by the user. Responsive to detecting the actuation of the hardware button, the electronic device illuminates 968 the illumination component to provide light in a vicinity of the electronic device.

Although not depicted in FIG. 9, it should be appreciated that the electronic device can periodically return to step 932 and receive updated contact data from the capacitive touch panel and examine the updated contact data to determine that the electronic device is no longer partially or fully submerged 934—“NO” branch. Accordingly, the electronic device can exit the operating mode and return to normal or default functionality.

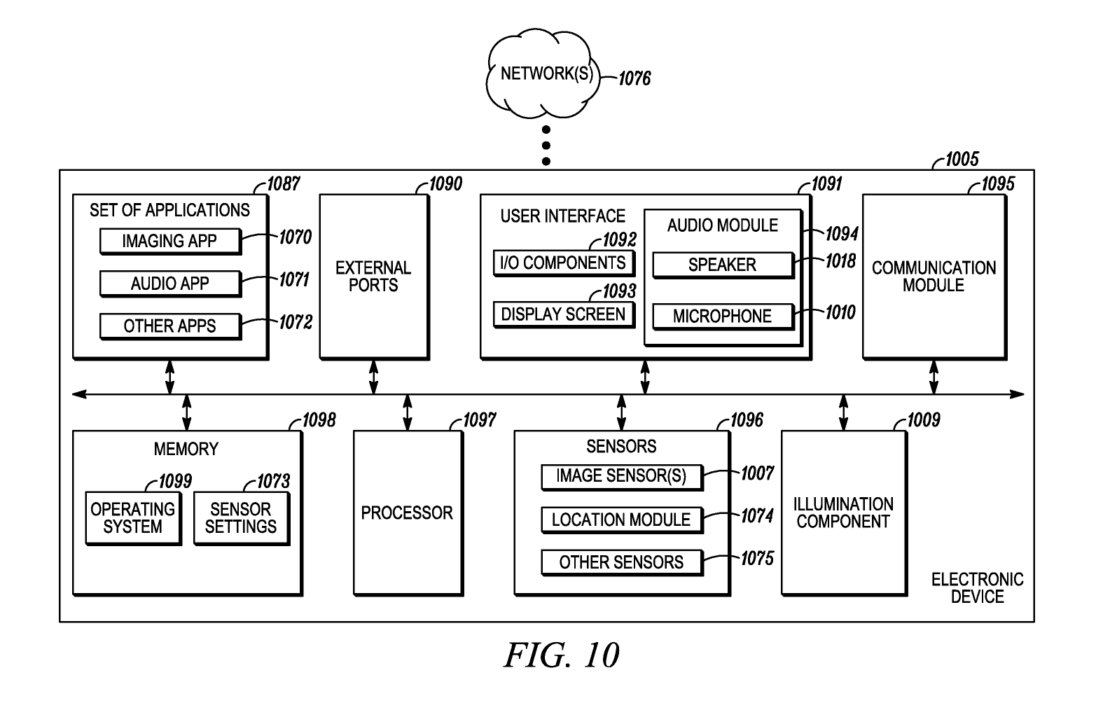

FIG. 10 illustrates an example electronic device 1005 (such as the electronic device 105 discussed with respect to FIG. 1, or other devices) in which the functionalities as discussed herein may be implemented. The electronic device 1005 can include a processor 1097 or other similar type of controller module or microcontroller, as well as a memory 1098. The memory 1098 can store an operating system 1099 capable of facilitating the functionalities as discussed herein. The processor 1097 can interface with the memory 1098 to execute the operating system 1099 and a set of applications 1087. The set of applications 1087 (which the memory 1098 can also store) can include an imaging application 1070 configured to capture digital images and video, as well as an audio application 1071 configured to capture audio. The set of applications 1087 can also include one or more other applications 1072 such as, for example, music and entertainment applications, phone applications, messaging applications, calendar applications, social networking applications, utilities, productivity applications, games, travel applications, communication application, shopping applications, finance applications, sports applications, photography applications, mapping applications, weather applications, applications for connecting to an online marketplace, and/or other applications.

Generally, the memory 1098 can include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 1005 can further include a communication module 1095 configured to interface with one or more external ports 1090 to communicate data via one or more networks 1076. For example, the communication module 1095 can leverage the external ports 1090 to establish a wide area network for connecting the electronic device 1005 to other components such as a remote data server. According to some embodiments, the communication module 1095 can include one or more transceivers functioning in accordance with IEEE standards, 3GPP standards, or other standards, and configured to receive and transmit data via the one or more external ports 1090. More particularly, the communication module 1095 can include one or more WWAN, WLAN, and/or WPAN transceivers configured to connect the electronic device 1005 to wide area networks, local area networks, and/or personal area networks. According to embodiments, the processor 1097 can enable or disable the communication module 1095 and/or the external ports 1090 depending on whether the electronic device 1005 is submerged.

The electronic device 1005 can further include one or more sensors 1096 such as one or more image sensors 1007 and a location module 1074. The electronic device 1005 can also include one or more other sensors 1075 such as, for example, accelerometers, gyroscopes, and/or proximity sensors, light sensors, infrared sensors, touch sensors, NFC components, and other sensors. The memory 1098 can further store a set of sensor settings 1073 that correspond to various settings of the sensors 1096. The processor 1097 may apply certain settings to certain sensors depending on a submersion state of the electronic device 1005.

The electronic device 1005 may further include a user interface 1091 configured to present information to the user and/or receive inputs from the user. As illustrated in FIG. 10, the user interface 1091 includes a display screen 1093 and I/O components 1092 (e.g., capacitive or resistive touch sensitive input panels, keys, buttons, lights, LEDs, cursor control devices, haptic devices, and others). In embodiments, the display screen 1093 is a touchscreen display using singular or combinations of display technologies and can include a thin, transparent touch sensor component superimposed upon a display section that is viewable by a user. For example, such displays include capacitive displays, resistive displays, surface acoustic wave (SAW) displays, optical imaging displays, and the like. The user interface 1091 may further include an audio module 1094 including hardware components such as one or more speakers 1018 for outputting audio data and one or more microphones 1010 for detecting or receiving audio.

In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 1097 (e.g., working in connection with the operating system 1099) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

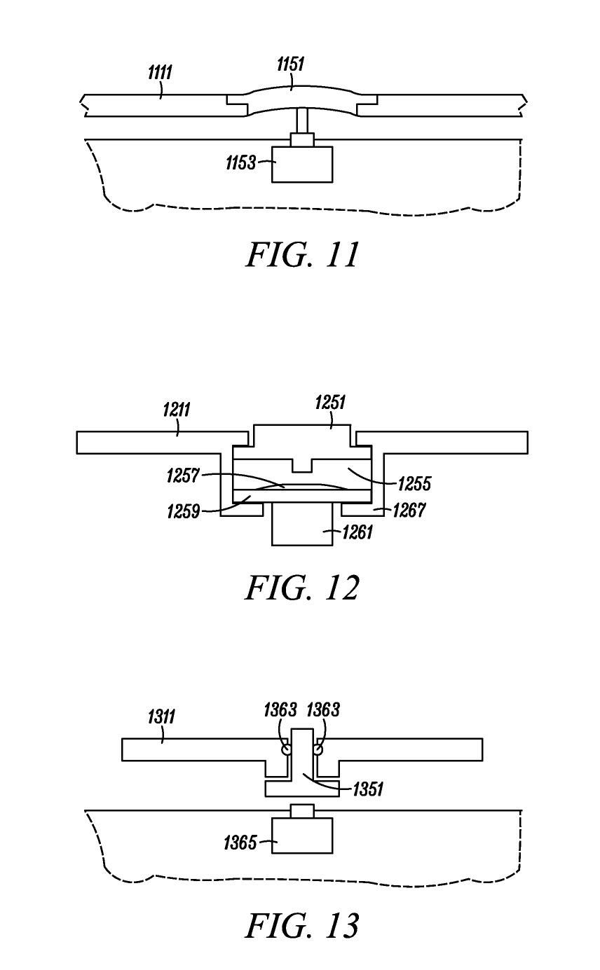

FIG. 11 depicts a cross-section view of actuator components associated with a configuration of an example hardware button of an electronic device, for example the hardware button 115 discussed with respect to FIG. 1. As illustrated in FIG. 11, an exterior casing 1111 of the electronic device can include a button 1151 disposed therein, wherein the button 1151 may be flexible and co-molded with the exterior casing 1111 so as to ensure a sealed (i.e., waterproof) external casing 1111. If depressed, the button 1151 actuates an actuator 1153 disposed on a printed circuit board.

FIG. 12 depicts a cross-section view of actuator components associated with an additional configuration of an example hardware button of an electronic device, for example the hardware button 115 discussed with respect to FIG. 1. An exterior casing 1211 of the electronic device includes a cutaway area with a button 1251, a waterproof actuator 1257, and a printed circuit board 1259 disposed therein. The printed circuit board 1259 may be sealed to a bottom ridge 1267 of the exterior casing 1211 to create a waterproof seal. Accordingly, the button 1251, the waterproof actuator 1257, and the printed circuit board 1259 form a flood chamber 1255 that fills with a conductive material (e.g., water) when the electronic device is partially or fully submerged, and drains the conductive material when the electronic device is not submerged. A connector 1261 to a main printed circuit board of the electronic device may be secured to a bottom surface of the printed circuit board 1259. If depressed, the button 1251 actuates the waterproof actuator 1257 and causes the printed circuit board 1259 to send an appropriate signal to the main printed circuit board.

FIG. 13 depicts a cross-section view of actuator components associated with a further configuration of an example hardware button of an electronic device, for example the hardware button 115 discussed with respect to FIG. 1. An exterior casing 1311 of the electronic device includes a cutaway area with a button 1351 disposed therein. An O-ring 1363 is secured around a stem of the button 1351 to secure the button 1351 to the exterior casing 1311 and to also create a waterproof seal. If depressed, the button 1351 actuates an actuator 1365 disposed on a printed circuit board.

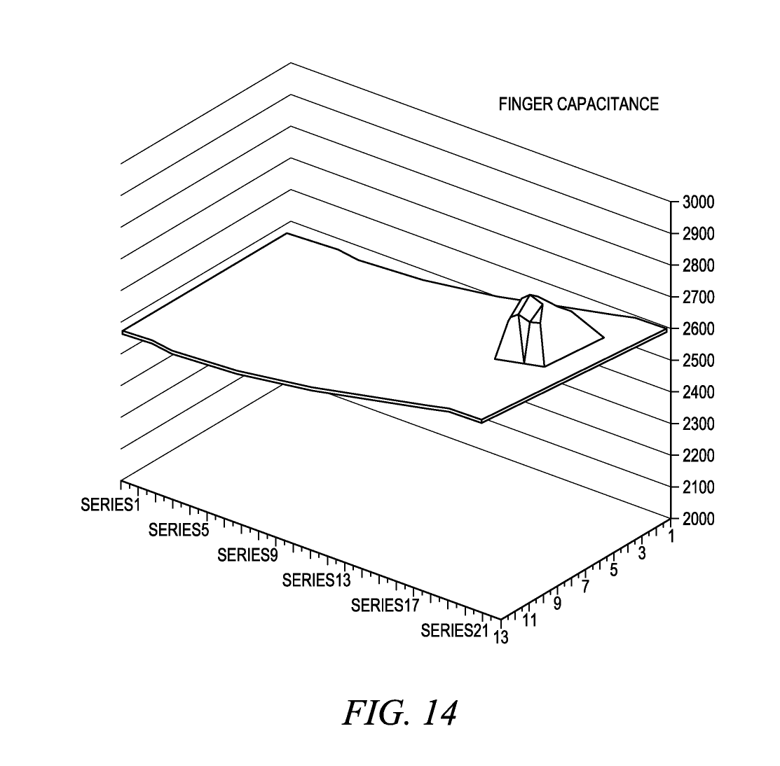

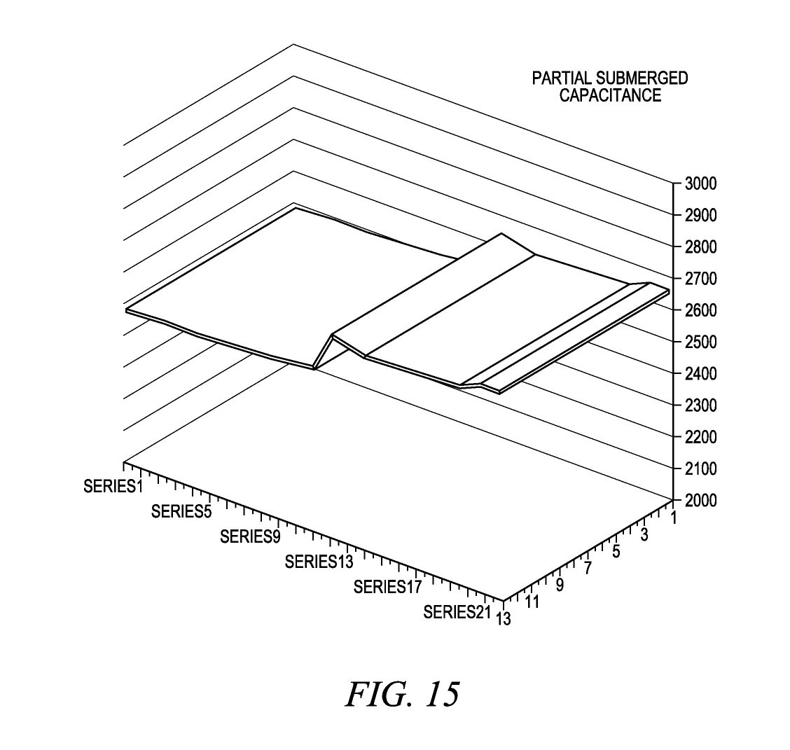

FIGS. 14-17 illustrate various graphs indicating measured capacitance values from a capacitive panel in response to various inputs. Referring to FIG. 14, illustrated is a measured capacitance of a capacitive panel in response to a human finger. The location of the human finger interaction causes a peak in capacitance value in relation to a reference capacitance (i.e., no capacitive input). FIG. 15 illustrates two distinct areas of measured capacitance values: the first area (left side) indicates a reference capacitance with no capacitive input and the second area (right side) indicates a measured capacitance when the corresponding area of the capacitive panel is submerged in a conductive material. The measured capacitance corresponding to the submerged area is greater than the reference capacitance.

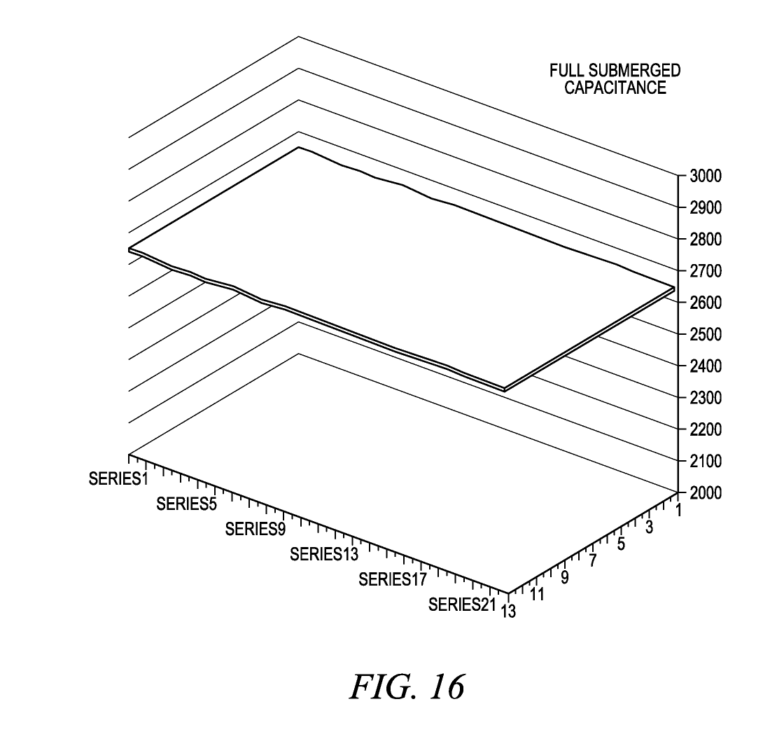

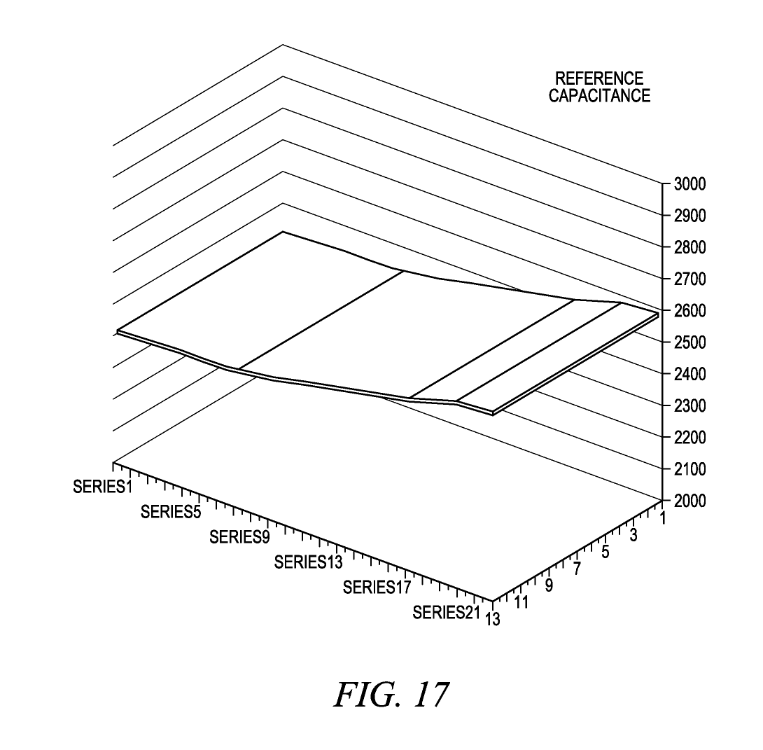

FIG. 16 indicates a consistent capacitance measurement resulting from the entire capacitive panel being submerged in a conductive material. FIG. 17 indicates a mostly uniform reference capacitance. As FIG. 16 and FIG. 17 indicate, the measured capacitance of the fully submerged capacitive panel is greater than the reference capacitance.

Thus, it should be clear from the preceding disclosure that the systems and methods offer increased usability of electronic devices. In particular, the embodiments enable users to interact with and facilitate operations of electronic devices while the electronic devices are submerged in a conductive material.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. An electronic device comprising:
an exterior casing;
at least one hardware button adapted for actuation by a user;
a user interface comprising:
a display screen configured to display content, and
a capacitive touchscreen panel configured to detect contact by a conductive material; and
a processor adapted to interface with the at least one hardware button and the user interface, wherein the processor is configured to:
receive contact data from the capacitive touchscreen panel,
determine, from the contact data, that the capacitive touchscreen panel is capacitively coupled to at least a portion of the exterior casing via the conductive material, and
in response to the determining, automatically initiate an operating mode that causes the display screen to indicate a function that is operable via the user actuating the at least one hardware button.

2. The electronic device of claim 1, further comprising:
an image sensor;
wherein the operating mode is an image capture application configured to:
cause the display screen to display a live preview of image data detected by the image sensor, and
cause the image sensor to capture the image data in response to the user actuating the at least one hardware button.

3. The electronic device of claim 2, wherein the image capture application is further configured to modify at least one setting associated with an image capture operation under default conditions.

4. The electronic device of claim 2, wherein the at least one hardware button includes a first hardware button and a second hardware button, and wherein the image capture application is further configured to:
cause the image sensor to zoom in response to the user actuating the first hardware button, and
cause the image sensor to capture zoomed image data in response to the user actuating the second hardware button.

5. The electronic device of claim 1, further comprising:
a microphone;
wherein the operating mode is an audio recording application configured to cause the microphone to capture audio data in response to the user actuating the at least one hardware button.

6. The electronic device of claim 1, wherein the at least one hardware button includes a first hardware button and a second hardware button, and wherein the processor automatically initiates the operating mode to:
cause the display screen to:
(1) display a menu associated with at least two operable functions, and
(2) scroll through the at least two operable functions in response to the user actuating the first hardware button, and
perform an operable function highlighted in the menu of the at least two operable functions in response to the user actuating the second hardware button.

7. The electronic device of claim 1, further comprising:
at least one wireless communication module;
wherein in response to the analyzing, the processor is further configured to disable the at least one wireless communication module.

8. The electronic device of claim 1, further comprising:
an illumination component;
wherein the operating mode is an illumination application configured to:
cause the display screen to indicate an illumination mode, and
cause the illumination component to illuminate in response to the user actuating the at least one hardware button.

9. The electronic device of claim 1, wherein the processor is further configured to:
receive updated data from the capacitive touchscreen panel,
determine, from the updated data, that the capacitive touchscreen panel is not capacitively coupled to the exterior casing via the conductive material, and
in response to the determining, automatically exit the operating mode.

10. A method for modifying an operation of an electronic device, the method comprising:
detecting contact data associated with a conductive material contacting a capacitive touchscreen panel of the electronic device;
analyzing the contact data to determine that the capacitive touchscreen panel is capacitively coupled, via the conductive material, to at least a portion of an exterior casing of the electronic device;
responsive to the analyzing, automatically displaying an indication of an operable function on a display screen of the electronic device;
detecting an actuation of a hardware button of the electronic device; and
executing the operable function in response to detecting the actuation.

11. The method of claim 10, wherein automatically displaying the indication of the operable function comprises:
automatically displaying, on the display screen, a live preview of image data detected by an image sensor of the electronic device;
and wherein executing the operable function in response to detecting the actuation comprises:
capturing the image data detected by the image sensor.

12. The method of claim 11, further comprising:
modifying at least one setting of an image capture application, wherein the at least one setting is associated with capturing images under default conditions.

13. The method of claim 11, wherein executing the operable function comprises:
zooming the image sensor;
and wherein the method further comprises:
detecting an additional actuation of an additional hardware button of the electronic device; and
capturing zoomed image data detected by the image sensor in response to detecting the additional actuation.

14. The method of claim 10, wherein executing the operable function in response to detecting the actuation comprises:
capturing audio data detected by a microphone of the electronic device.

15. The method of claim 10, wherein executing the operable function comprises:
scrolling through a menu displayed on the display screen, wherein the menu is associated with at least two operations;
and wherein the method further comprises:
detecting an additional actuation of an additional hardware button of the electronic device; and
executing an operation highlighted in the menu of the at least two operations in response to detecting the additional actuation.

16. The method of claim 10, further comprising:
responsive to the analyzing, disabling at least one wireless communication module of the electronic device.

17. The method of claim 10, wherein automatically displaying the indication of the operable function comprises:
indicating an illumination mode on the display screen;
and wherein executing the operable function comprises:
illuminating an illumination component of the electronic device.

18. The method of claim 10, further comprising:
detecting updated contact data associated with the capacitive touchscreen panel;
analyzing the updated contact data to determine that the capacitive touchscreen panel is not capacitively coupled to the exterior casing via the conductive material; and
automatically initiating a default operating mode in response to analyzing the updated contact data.

19. An electronic device comprising:
an exterior casing;
a capacitive panel configured to detect contact by a conductive material;
at least one wireless communication module; and
a processor adapted to interface with the capacitive panel and the at least one wireless communication module, wherein the processor is configured to:
receive contact data from the capacitive panel,
determine, from the contact data, that the capacitive panel is capacitively coupled to at least a portion of the exterior casing via the conductive material, and
in response to the determining, automatically disable the at least one wireless communication module.

20. The electronic device of claim 19, wherein the processor is further configured to:
receive updated data from the capacitive panel,
determine, from the updated data, that the capacitive panel is not capacitively coupled to the exterior casing via the conductive material, and
in response to the determining, automatically activate the at least one wireless communication module.
